(19) United States
(12) Patent Application Publication
(10) Pub. No.: US 2008/0119070 A1
(43) Pub. Date: May 22, 2008

(54) Electrical Connector

(75) Inventor: Meng-Huan Yang, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/986,392

(22) Filed: Nov. 21, 2007

(30) Foreign Application Priority Data
Nov. 21, 2006 (CN) 200620125762.5

(51) Int. Cl. H01R 12/24

(52) U.S. Cl. 439/77

(57) ABSTRACT

An electrical connector adapted for connecting a camera module to a printed circuit board, at least comprising: a lower shield having a bottom wall, a plurality of sidewalls extending from the bottom wall, and a receiving space defined between the bottom wall and the sidewalls, the receiving space has a supporting surface. A flexible printed circuit placed upon the supporting surface for electrically connecting the camera module. An upper shield secured to the lower shield and comprising a top wall, and a plurality of side walls extending from the top wall, said at least one of the side walls defining a second plate element horizontally extending from the bottom end of the side wall, and at least one assembling hole formed in the second plate element for assembling the electrical connector in the printed circuit board.

### BACKGROUND OF THE INVENTION

1. Field of the Invention

The present invention relates to an electrical connector, and more particularly to an electrical connector used for electrically interconnecting a camera module with a substrate such as a printed circuit board. The connector of present invention features a position device such that the connector can be securely position on the substrate.

2. Description of the Prior Art

Due to the development of the information and communication technology industry, various types of portable wireless terminals such as mobile phones, Personal Digital Assistant always simply called as PDA and so forth. Said terminals are provided with various functions, for example, e-mail reception and transmission, Internet games and text transmission. Beyond the above basic functions, recently, image communication as a new function is introduced. As a result, said various portable wireless terminals are additionally provided with camera module, correspondingly, electrical connectors are used for connecting with the camera modules are also provided and also disclosed in U.S. Patent Publication No. 2003/0218873.

However, the electrical connectors abovementioned are usually mounted onto the printed circuit board by surface mounting technology (SMT) and the component surface attached by SMT should be plated electroplated layer for mated each other. In addition, the components involved should have smoothly surface and higher coplanar demand. So the connectors manufacture have to spend much time and labor to adjust the coplanar character between components, hence leading to a higher cost and complicate manufacture process.

Thus, there is a need to provide a new electrical connector that overcomes the above-mentioned problems.

### SUMMARY OF THE INVENTION

Accordingly, an object of the present invention is to provide an electrical connector used for connecting with a camera module, which has securing element, wherein the securing element is configured to securely and reliably attach the connector assembled the camera module to a printed circuit board.

To fulfill the above-mentioned object, an electrical connector adapted for connecting a camera module to a printed circuit board, at least comprising: a lower shield having a bottom wall, a plurality of sidewalls extending from the bottom wall, and a receiving space defined between the bottom wall and the sidewalls, the receiving space has a supporting surface. A flexible printed circuit placed upon the supporting surface for electrically connecting the camera module. An upper shield secured to the lower shield and comprising a top wall, and a plurality of side walls extending from the top wall, said at least one of the side walls defining a second plate element horizontally extending from the bottom end of the side wall, and at least one assembling hole formed in the second plate element for assembling the electrical connector in the printed circuit board.

In relative to conventional electrical connectors, the electrical connector of the invention defines at least one second plate element having two holes which can fix the connector onto the printed circuit board with a fixing element, hence decreasing accuracy of match among between the electrical connector and the printed circuit board, and manufacturing at a lower cost.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded, isometric view of an electrical connector in accordance with the present invention;

FIG. 2 is an assembled view of the electrical connector with other elements such as camera module;

FIG. 3 is an assembled view of the electrical connector with another elements such as camera module, printed circuit board; and

FIG. 4 is an exploded, isometric view of the electrical connector with another elements such as camera module.

### DESCRIPTION OF PREFERRED EMBODIMENT OF THE INVENTION

Reference will now be made to the drawings to describe the present invention in detail.

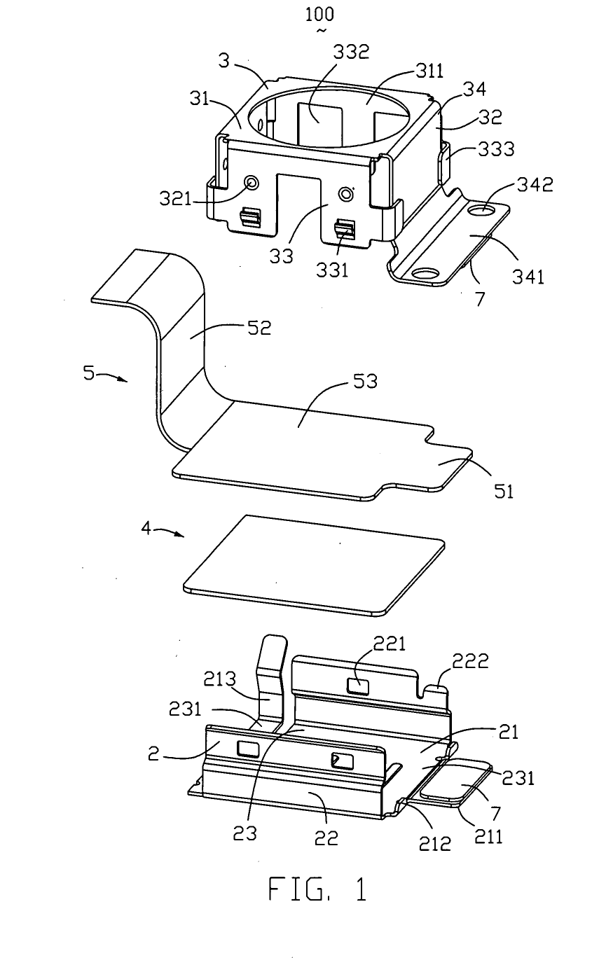

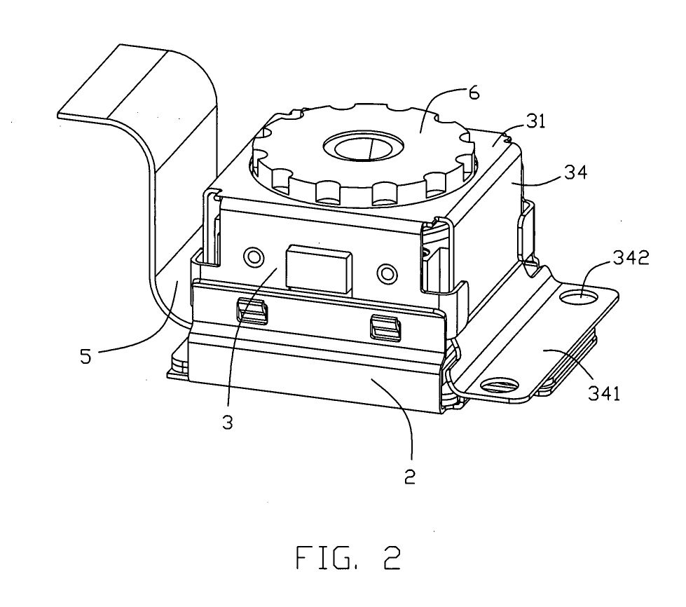

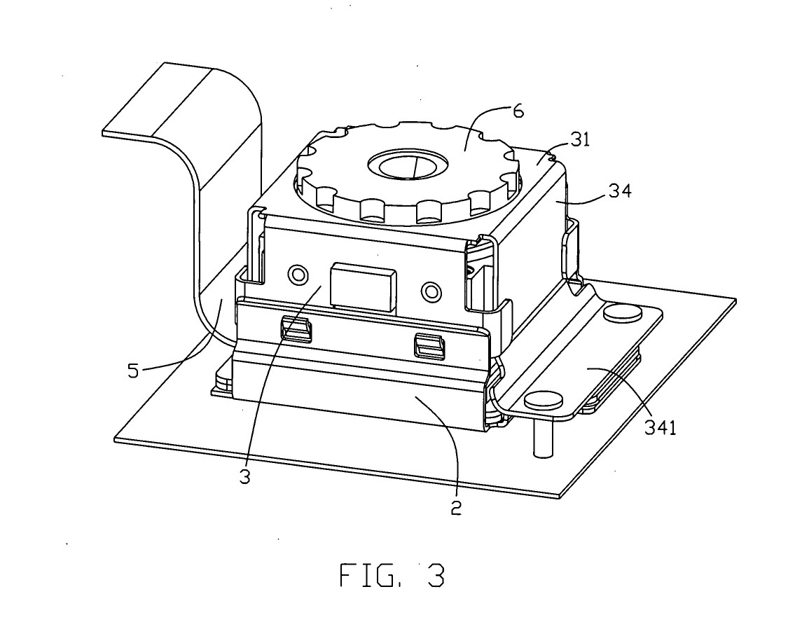

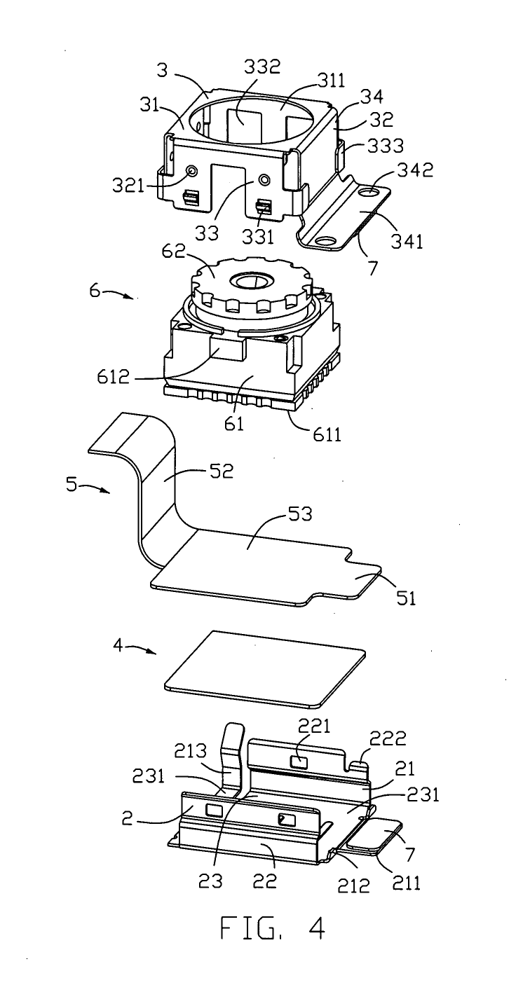

Referring to FIGS. 1-4, an electrical connector 100 comprises a lower shield 2, an upper shield 3, a support element 4 and a flexible printed circuit 5. The electrical connector 100 is adapted for receiving a camera module 6 therein. In an alternative embodiment, the electrical connector 100 may receive a memory module or likes.

The lower shield 2 is substantially rectangular case, comprising a bottom wall 21 and two opposite sidewalls 22 extending upwardly from the bottom wall 21 to thereby define a rectangular receiving space 23 therebetween. The receiving space 23 includes a supporting surface (not labeled) for supporting the support element 4 or the flexible printed circuit 5, and two cutouts 231 defined at the opposite ends of the bottom wall 21. A first plate element 211 horizontally extends outwardly from an edge of the bottom wall 21, two tabs 212 adjacent the first plate element 211 extending vertically from the edge of the bottom wall 21 and controlling the position of penetration of the camera module 6. One of the sidewalls 22 defines a fixing notch 221 in the middle position of the sidewall 22, and a flexible finger 222 adjacent the fixing notch 221 extending slightly into the receiving space 23 partially for providing an elastic force to the camera module 6. In other sidewall 22, two fixing notches 221 defined abreast. In addition, an earthing element 213 protruding upwardly from an edge of the bottom wall 21, and the earthing element 213 connecting with the earthing structure of an electrical device (not shown) for effectively reducing the electromagnetic interference of the camera module 6.

The upper shield 3 comprises a top wall 31 and four side walls 32 extending downwardly from the top wall 31. The side walls 32 further comprise a pair of opposite primary walls 33 and a pair of opposite vertical walls 34. The top wall 31 has a central hole 311 for partial extension of the camera module 6 and a plurality of salient point 321 respectively defined in the side walls 32 for providing an elastic force to the camera module 6. Each the primary wall 33 defines therein at least one fixing portion 331 corresponding to the fixing notch 221 of the lower shield 2, and a plurality of rectangular openings 332 respectively defined adjacent the fixing portion 331 for fixing the camera module 6 with mating structure of the camera module 6. The upper shield 3 has a second plate element 341 horizontally extending from the bottom end of the vertical wall 34. The second plate element 341 is formed with two paratactic assembling holes 342 for assembling the electrical connector 100 in a printed circuit board (not labeled). In addition, a pair of opposite edges of the each primary wall 33 defines a strengthening portion 333 respectively, paralleling with the vertical wall 34. The strengthening portion 333 fixes the vertical wall 34 and increases the integrated intensity of the upper shield 3.

The support element 4 and the bottom wall 21 of the lower shield 2 have an equivalent size for allowing the support element 4 retained in the lower shield 2.

The flexible printed circuit 5 comprises a rectangular first end portion 51, a second end portion 52 having a flexibility and a connecting portion 53 connecting the first end portion 51, the second portion 52 together. The connecting portion 53 has an approximate size with the bottom wall 21 of the lower shield 2 and has a plurality of electronic circuits (not shown) provided therein. The first end portion 51 has an approximate size with the first plate element 211 of the lower shield 2.

The camera module 6 comprises a rectangular base portion 61 having a plurality of conductive strips (not shown) provided on the bottom surface 611 thereof, a columned protruding portion 62 extending upwardly from a center of the base portion 61. The base portion 61 has a plurality of anti-mismating blocks 612 formed at the pair of opposite sides thereof corresponding to the rectangular openings 332 of the upper shield 3.

In assembly, the support element 4 is firstly mounted into the bottom wall 21 of the lower shield 2. Secondly, the flexible circuit board 5 is assembled to the support element 4 and upwardly supported by the support element 4. The connecting portion 53 is positioned above the support element 4 and is retained in the receiving space 23 of the lower shield 2. The first end portion 51 and the second end portion 52 extend outwardly through the cutouts 231 of the lower shield 2 respectively. The first end portion 51 is positioned above the first plate element 211 and is glued with the first plate element 211 by a conductive adhesive 7. The camera module 6 is then inserted into the receiving space 23 of the lower shield 2 with the conductive strips thereof electrically engaging with the conductive circuits of the flexile circuit board 5. Finally, the upper shield 3 is assembled to the camera module 6, with the central hole 311 thereof receiving the protruding portion 62 and is buckled with the lower shield 2. The anti-mismating blocks 612 are engaged with the rectangular openings 332 of the upper shield 3. The upper shield 3 is enclosed in the lower shield 2 partially, with the fixing portions 331 thereof engaging with the notches 221 of the lower shield 2. Thus, the flexible finger 222 resisted against the primary wall 33 of the upper shield 3. At the same time, the second plate element 341 accompanied by the conductive adhesive 7 and positioned above the first end portion 51 of the flexible circuit board 5.

The electrical connector 100 may be further has a printed circuit board having two mating holes (not labeled) corresponding to the assembling holes 342 of the upper shield 3 as the case may be. The electrical connector 100 assembled the camera module 6 is attached to the printed circuit board by the holes and the mating element such as nut (not labeled), hence detachably mounting to the electronic device conveniently. In addition, the electrical connector 100 with design of the shields 2, 3 wrapping the camera module 6, the earthing element 213 connecting the electronic device and the conductive adhesive 7 gluing the first end portion 51 of the flexible circuit board 5, the electromagnetic interference can be effectively diminished to stabilize the transmission of electronic signal of the camera module 6.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An electrical connector adapted for connecting a camera module to a printed circuit board, at least comprising:
a lower shield having a bottom wall, a plurality of sidewalls extending from the bottom wall, and a receiving space defined between the bottom wall and the sidewalls, the receiving space has a supporting surface;
a flexible printed circuit placed upon the supporting surface for electrically connecting the camera module; and
an upper shield secured to the lower shield and comprising a top wall, and a plurality of side walls extending from the top wall, said at least one of the side walls defining a second plate element horizontally extending from the bottom end of the side wall, and at least one assembling hole formed in the second plate element for assembling the electrical connector in the printed circuit board.

2. The electrical connector according to claim 1, wherein a first plate element horizontally extending from the end of the bottom wall of the lower shield, and corresponding to the second plate element.

3. The electrical connector according to claim 2, wherein the second plate element further comprising a second assembling hole spaced apart from the first assembling hole, and the distance between the holes is greater than the length of the first plate element.

4. The electrical connector according to claim 3, wherein two opposite surfaces belong to the plate elements respectively accompanied by a conductive adhesive.

5. The electrical connector according to claim 4, wherein said side walls of the upper shield comprise a pair of vertical walls and a pair of primary walls.

6. The electrical connector according to claim 5, wherein said receiving space has two cutouts defined at the opposite ends of the bottom wall of the lower shield and wherein the flexible printed circuit comprises a first end portion and a third end portion respectively extending outwardly through the cutouts.

7. The electrical connector according to claim 6, wherein the plate elements sandwich the first end portion of the flexible printed circuit.

8. The electrical connector according to claim 7, wherein the electrical connector further comprising a support element placed upon the supporting surface of the lower shield for supporting the flexible printed circuit.

9. The electrical connector according to claim 8, wherein an earthing element protruding upwardly from the bottom wall of the lower shield.

10. The electrical connector according to claim 9, wherein said primary walls of the upper shield each has at least one fixing portion outwardly from an outer surfaces thereof, and the sidewalls of the lower shield define at least one fixing notch corresponding to the fixing portion.

11. The electrical connector according to claim 10, wherein said primary wall of the upper shield defines a rectangular opening for fixing the camera module.

12. The electrical connector according to claim 11, wherein the bottom wall of the lower shield having at least one flexible finger extending into the receiving space partially for providing an elastic force to the camera module.

13. An electrical connector, at least comprising:
a lower shield having a bottom wall, a plurality of sidewalls extending from the bottom wall, and a receiving space defined between the bottom wall and the sidewalls, the receiving space has a supporting surface;
a flexible printed circuit placed upon the supporting surface for electrically connecting the camera module;
an upper shield secured to the lower shield and comprising a top wall, and a plurality of side walls extending from the top wall, said at least one of the side walls defining a second plate element horizontally extending from the bottom end of the side wall, and at least one assembling hole formed in the second plate element; and
a printed circuit board has at least one mating hole corresponding to the assembling hole of the printed circuit board.

14. The electrical connector according to claim 13, wherein a first plate element horizontally extending from the end of the bottom wall of the lower shield, and corresponding to the second plate element.

15. The electrical connector according to claim 14, wherein the second plate element further comprising a second assembling hole spaced apart from the first assembling hole abreast, and the distance between the holes is greater than the length of the first plate element.

16. The electrical connector according to claim 15, wherein the printed circuit board further comprising a second mating hole corresponding to the second assembling hole.

17. The electrical connector according to claim 16, wherein two opposite surfaces belong to the plate elements respectively accompanied by a conductive adhesive.

18. The electrical connector according to claim 17, wherein the electrical connector further comprising a support element placed upon the supporting surface of the lower shield for supporting the flexible printed circuit.

19. An electrical connector assembly comprising:
an upper metallic shell defining a horizontal top wall and four vertical side walls extending downwardly from the top wall to cooperate with said top wall for commonly defining a module receiving space, and a horizontal retention wall extending from one of said side walls;
a lower metallic shell defining a bottom plate and two opposite side plate extending upwardly from the bottom plate and locked to opposite two of said four vertical side walls, and a horizontal retention plate extending from the bottom plate in alignment with the retention wall;
a camera module received in the module receiving space;
a flexible printed circuit board extending into the module receiving space under said camera module with a front end section sandwiched between said retention plate and said retention wall.

20. The assembly as claimed in claim 19, further including a printed circuit board which said lower metallic shell is seated on and said retention wall is fastened to.
